(19) United States
(12) Patent Application Publication
(10) Pub. No.: US 2011/0198316 A1
(43) Pub. Date: Aug. 18, 2011

(54) METHOD AND APPARATUS FOR MEASURING A PIPE WELD JOINT

(75) Inventors: Roberto Legori, Milan (IT); Marco Novello, Venice (IT); Eric Kerdilès, Marcq (FR); Rachid Yousfi, Verneuil Sur Seine (FR); Andrea Provesi, Piacenza (IT)

(73) Assignee: SAIPEM S.p.A., Milan (IT)

(21) Appl. No.: 13/123,993

(22) PCT Filed: Oct. 21, 2009
(86) PCT No.: PCT/EP09/63791

§ 371 Date: Apr. 13, 2011

(30) Foreign Application Priority Data
Oct. 22, 2008 (GB) 0819377.3

(51) Int. Cl. B23K 31/02

(52) U.S. Cl. 219/61.1

(57) ABSTRACT

An internal line-up clamp (20), for aligning two pipes to be welded together, includes a hi-lo measurement system, for example includes a laser source (24) and camera system (22), mounted on the internal line-up clamp (20) and arranged to make a hi-lo measurement (d), indicative of the degree of alignment of the pipes (10a, 10b). The measurement may be made when two pipes are clamped together by means the internal line-up clamp (20). The pipes may then be welded together, whilst the pipes remain clamped together in the same position, and whilst the hi-lo measurement system remains inside the pipes.

### BACKGROUND OF THE INVENTION

The present invention relates to a method and apparatus for measuring the alignment between two pipes to be welded together, particularly pipes to be welded together to form a pipeline for transportation of oil or gas.

When laying an oil pipeline it is typically necessary to weld a section of pipe to an end of a pipeline. The pipeline may be laid at sea. The welded joints between successive sections of pipe typically need to be of high quality and integrity, because underwater pipelines are typically subjected to cyclic loading both during and after the laying process, giving rise to a risk of weakening of the joints through fatigue loading. Misalignment of the pipe-ends when effecting a weld joint between the pipeline and a new section of pipe affects the quality of the weld produced. The accurate welding together of two pipe-ends is therefore important. Consequently, it is desirable to measure the degree of misalignment before and/or after the welding process.

FIG. 1 is a partial cross-sectional view of two pipes 10a, 10b arranged end-to-end. The ends of the pipes are bevelled so that a joint 12 to be welded is defined between the pipe ends. As can be seen in FIG. 1, there is a degree of misalignment between the two ends of the pipes 10a, 10b. The interior surface 14a of one pipe 10a is separated in the radial direction from the interior surface 14b of other pipe 10b, by a distance, d. The distance d is commonly referred to simply as the “high-low”, or “hi-lo”, or as the “high-low value” or “hi-lo value”.

The hi-lo value may vary along the circumference of the inner surface of the pipes. The hi-lo value in the context of the present invention refers to the separation, if any, in the radial direction, of a point on the inner surface of one pipe end from an adjacent point on the inner surface of the adjacent pipe end. The misalignment of the exterior surfaces of the pipes may relate to the hi-lo measurement, but is of itself of less interest and relevance in the present invention.

For the reasons mentioned above, it is desirable to measure the degree of misalignment between the pipe ends, and take appropriate action in dependence on the measurement so made, to improve the quality of the weld between the pipes. Prior art methods of measuring the degree of misalignment between the pipe ends typically involves calculating or measuring the hi-lo value.

WO01/70446 discloses apparatus for monitoring the alignment of pipes to be welded together. The apparatus is mounted on the exterior of the pipes. It would seem that the apparatus for measuring the alignment of pipes needs to be moved out of the way in order to allow welding apparatus to weld the pipes together. It would seem most likely that, after measuring the pipe alignment, the pipes are moved to a welding station. The pipes are therefore moved before welding possibly changing their relative alignment.

WO06/112689 also discloses apparatus for monitoring the alignment of pipes to be welded together. In one embodiment, the pipes are held in end-to-end configuration by means of pipe manipulators, arranged to the exterior of the pipes. The pipes are held so that their ends are slightly spaced apart, so that the pipes may be moved relative to each other without the pipe ends abrading each other. In one embodiment, a sensing device is inserted inside the pipes to scan the interior surface of the pipe. Once the interior of the pipes have been scanned, the pipes are moved relative to each other to attain a target alignment, in which the pipe ends are brought into contact with each other ready for welding together.

Both of the above examples of the prior art suffer from the problem that the welding is performed on the pipes after they have been moved from the position in which the alignment measurement was performed. The relevance and usefulness of the alignment measurement is therefore compromised. For example, if the alignment measurement is performed before the welding process, in conditions that differ from the ones immediately before welding, the alignment measurement may be subject to errors and be different from the alignment as would be measured after welding.

The present invention seeks to mitigate one or more of the above-mentioned problems. Alternatively or additionally, the present invention seeks to provide an improved method and apparatus for measuring the alignment between two pipes to be welded together.

### SUMMARY OF THE INVENTION

The present invention provides an internal line-up clamp for aligning two pipes to be welded together, wherein the internal line-up clamp includes a hi-lo measurement system mounted on the internal line-up clamp and arranged to make a hi-lo measurement when two pipes are clamped together by means the internal line-up clamp.

Thus, the internal line-up clamp (or ILUC) may be used in a method of welding two pipes together, wherein the hi-lo measurement system is able to obtain an indication of the degree of alignment of the pipes in the region of the joint, whilst the pipes are clamped together in exactly the same position as they will be when performing welding. If the pipes are deemed to be clamped together in satisfactory alignment with each other, there is then, for example, no need to move the two pipes relative to each other, or relative to the welding apparatus, the ILUC or the hi-lo measurement system in order to effect welding. Thus, the conditions in which the hi-lo measurement is effected are very close to the conditions in which the welding of the pipes is effected. Systems of the prior art on the other hand have adopted methods in which the alignment measurement is performed after the welding, potentially revealing alignment problems after the weld has been formed, possibly requiring re-welding. Other systems of the prior art have adopted methods in which measurements are made in conditions that differ from the final ones, potentially leading to measurement errors and incorrect determinations concerning the alignment or misalignment of the pipes. Embodiments of the present invention enable the hi-lo measurement to be effected immediately before the welding of the pipes, in conditions that are very close to the welding conditions.

The hi-lo measurement system may be in the form of a no-contact measurement system, for example an optical measurement system. The optical measurement system may include a camera system. The optical measurement system may include a light source. The light source may be a reference light source arranged to provide assistance to the camera system in ascertaining the profile of the joint to be welded. The reference light source may for example be in the form of a recognisable shape or pattern, for example a flat sheet of light which would be reflected from a perfectly flat surface as a straight line. The camera may be arranged to detect the reference light pattern as reflected by the interior of the pipes.

The hi-lo measurement system may include a camera mounted inside the internal line-up clamp. The camera may thus be protected from dust and high temperatures produced during the welding process. The camera may be associated with one or more mirrors in order to perform its function from its position inside the ILUC.

The hi-lo measurement system may be mounted midway along the length of the internal line-up clamp.

The hi-lo measurement system may be arranged to measure the hi-lo value at a plurality of different points around the circumference of the pipes. The hi-lo measurement system may be arranged to measure the hi-lo value substantially continuously around the circumference of the pipes. More than 100 measurements may be made over the circumference of the pipes. The hi-lo measurement system may be mounted for movement along the line of the joint (for example so that it rotates around the axis of the pipes).

The hi-lo measurement system may be powered by means of a local power supply. The local power supply may be associated with the ILUC. The ILUC may include the local power supply, for example a battery. The ILUC may additionally, or alternatively, be powered by means of power delivered to it via an umbilical.

The present invention also provides a method of measuring the hi-lo value for example during a method of welding two pipes together. The method may include a step of clamping two pipes in end-to-end configuration to define therebetween a joint to be welded. The method may include a step of obtaining, by means of a measurement system positioned inside the pipes, an indication of the degree of alignment of the pipes in the region of the joint, for example whilst the pipes are clamped together. The method may include a step of welding together the two pipes, whilst the measurement system remains inside the pipes and in the region of the joint. Preferably, the step of clamping the two pipes together is performed before the step of obtaining the indication of the degree of alignment of the pipes. Preferably, the step of obtaining the indication of the degree of alignment of the pipes is performed before (preferably immediately before) the step of welding together the two pipes.

The step of clamping may include completing fit-up operations. Preferably, before commencement of the step of obtaining the indication of the degree of alignment of the pipes, all operations necessary to enable welding of the pipes are completed. The step of clamping the two pipes together may be performed from within the pipes. An internal clamping system may be used.

The two pipes may be clamped in end-to-end configuration, with one end touching the other, thereby defining the joint to be welded.

The internal clamping system may be an internal line-up clamp (ILUC) according to any aspect of the present invention.

The measurement system may be a hi-lo measurement system. The measurement system may be mounted on an internal line-up clamp for clamping together the pipes. The measurement system may be a hi-lo measurement system according to any aspect of the present invention.

The step of obtaining an indication of the degree of alignment of the pipes may include rotating the measurement system about the axis of the pipes.

During the step of welding, the measurement system may be positioned directly adjacent to the joint.

The step of welding may include, at least during the initial stages of the welding process, introducing a gas, for example a shielding gas, in the region of the welding. The step of welding may be performed wholly from the exterior of the pipes. The joint when being welded may be unsupported from the interior of the pipes. There may be no need for a copper backing shoe or the like.

The method may include a step of electronically processing data from the measurement system acquired during the step of obtaining the indication of the alignment of the pipes. During such a data processing step, the acquired data may be compared with reference data. As a result of such a data processing step, a decision may be made, preferably automatically, as to whether the pipes are sufficiently well aligned for welding, or not. The reference data could simply be criteria such as whether each of the hi-lo values is within an acceptable range of threshold values. The magnitude of the hi-lo value could for example be compared with a single threshold value. In such a case, the reference data may consist or comprise of a threshold hi-lo value. The electronic processing of the data could alternatively involve deciding whether the average of the magnitude of the hi-lo value is within an acceptable range. The reference data may include data resulting from previous experimentation concerning the correlation between (i) hi-lo measurement data for different joints and (ii) the acceptability of the joint when welded, for example, as a result of fatigue load testing post-welding. The data acquired during performance of the method (for example, in the field) may be processed before comparison with such reference data. The acquired data may for example be normalised to allow objective comparison with the reference data.

The pipes may have an internal diameter greater than 100 mm. The pipes may have an internal diameter greater than 150 mm. The pipes may have an internal diameter up to 600 mm. The pipes may have an internal diameter up to 1,000 mm. The present invention is of particular application in relation to the welding of pipes which have an internal diameter from 300 mm to 900 mm.

The present invention also provides a hi-lo measurement system suitable for use as the hi-lo measurement system as described herein with reference to any aspect of the present invention. The hi-lo measurement system of the invention may for example be used to convert an ILUC of the prior art into an ILUC in accordance with the present invention.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

An embodiment of the present invention will now be described by way of example only with reference to the accompanying schematic drawings of which:

FIG. 1 is a partial cross-sectional view of two pipes arranged end-to-end showing the hi-lo distance to be measured;

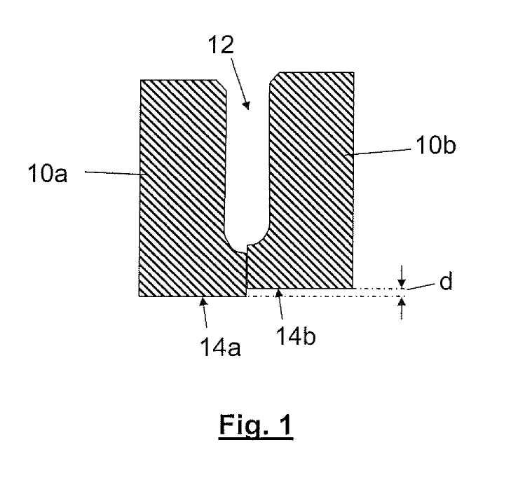

FIG. 2 is a perspective view of an internal line-up clamp according to a first embodiment of the invention;

FIG. 3 is a perspective view of a conventional internal line-up clamp for aligning two pipes in end-to-end configuration;

FIG. 4 is a perspective view of a hi-lo measurement system of the internal line-up clamp of FIG. 3; and

FIG. 5 is a plan view of the hi-lo measurement system of FIG. 4.

### DETAILED DESCRIPTION

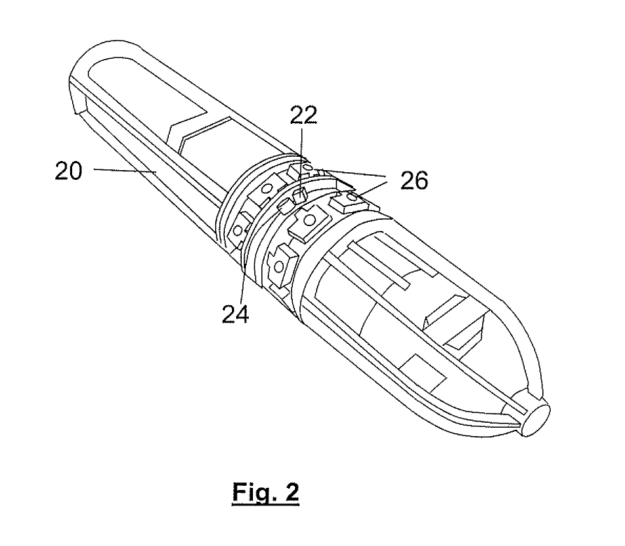

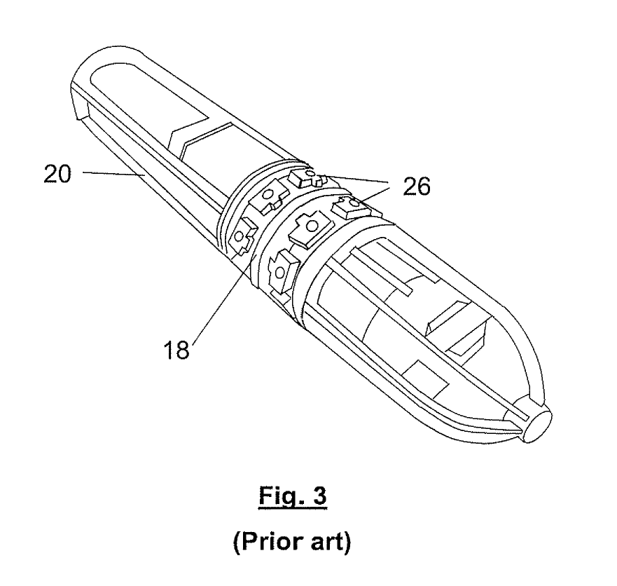

An embodiment of the present invention is shown in FIG. 2 and includes an internal line-up clamp (ILUC) device 20 on which there is mounted a hi-lo measurement system. The hi-lo measurement system includes a camera 22 and a laser light source 24, both of which being illustrated schematically in FIG. 2. A conventional internal line-up clamp device is shown in FIG. 3. The ILUC device is attached to an umbilical (not shown). The ILUC device 20 has two sets of expandable clamp members 26 spaced around the circumference of the device 20, one set being associated with one pipe end and the other set being associated with the other pipe end. The ILUC device 20 holds two pipes (not shown in FIG. 3) in end-to-end configuration by means of expanding the clamp devices 26 so that they all move outwardly in the radial direction and engage the inner surfaces of the pipes. A welding apparatus mounted on the exterior of the pipes may then weld the joint between the two pipe ends. A copper backing plate 18 (or shoe) is typically provided to assist in this welding process, and during welding the copper plate 18 is urged against the interior walls of the pipes to support the weld joint.

It will be seen that the internal line-up clamp device of FIG. 2 (in accordance with the embodiment of the invention) is very similar to the device shown in FIG. 3, apart from the fact that the internal line-up clamp device of FIG. 2 includes a hi-lo measurement system in place of the copper backing plate. In use, it will be appreciated that the hi-lo measurement system is thus arranged directly adjacent to the joint.

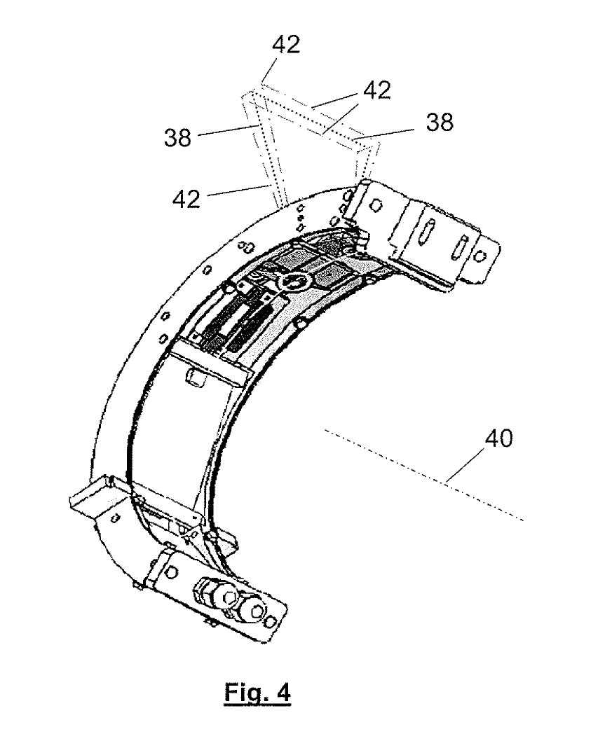

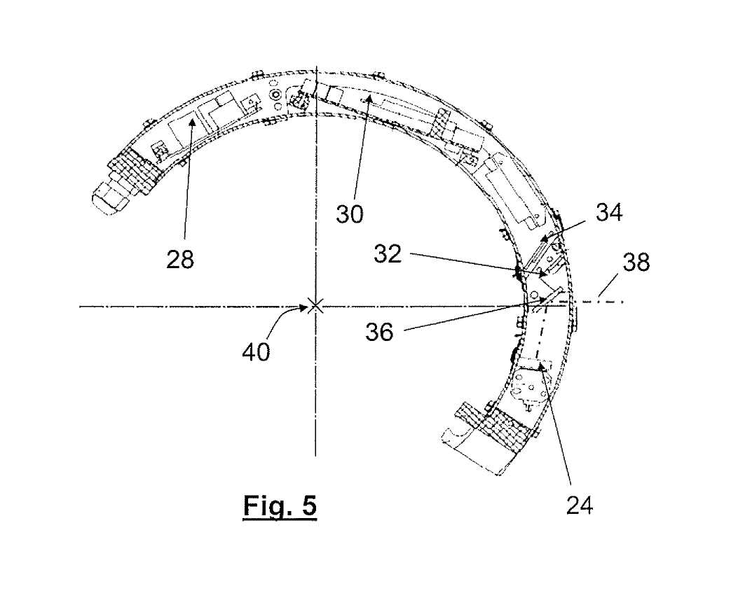

FIGS. 4 and 5 show in greater detail the hi-lo measurement system separate from the internal line-up clamp device 20. The hi-lo measurement system is generally arcuate in shape when viewed from the side (see FIG. 5) and extends around about half of the circumference of the pipes. The hi-lo measurement system when installed on the internal line-up clamp device is mounted for movement along the joint (i.e. it rotates about the longitudinal axis 40 of the pipe). For this purpose the hi-lo measurement system includes a motor (not shown in FIGS. 4 and 5) powered by a local power supply 28 disposed on the hi-lo measurement system.

As mentioned above, the hi-lo measurement system includes a camera system and a laser light source 24. The camera system 22 comprises a camera-image converter board 30, a camera lens 32, and a CMOS (active-pixel sensor) 4 mega-pixel camera chip 34. The light from the laser light source 24 is in use reflected by a mirror 36 so that the light is emitted in a radial direction. The components 30, 34 forming the camera system and the laser light source 24 are powered by the local power supply 28. By providing a local power supply, for example in the form of a rechargeable battery, there is no need to draw power via the umbilical connected to the ILUC device 20.

The hi-lo measurement system is based on an optical triangulation method between the camera's field of view and a laser line projected orthogonally to the joint to be welded. Thus, in use, laser light 38 is produced by the light source 24 in the form of a beam of light divergent in only one plane thus producing a flat sheet of light 38, which is reflected by the mirror 36 so that the interior surface of the pipe in the region of the joint to be welded is illuminated by a line of laser light 38. The line of light incident on the interior surfaces of the pipes is orientated parallel to the longitudinal axis 40 of the pipes. As a result of the planar nature of the emitted light, any steps from one pipe end to the other will be revealed by means of a corresponding step in the line of light on the surface of the pipes. The camera system views the incident light via the lens 32, and thus receives a visual indication of the profile of the joint to be welded. The camera's field of view is illustrated schematically in FIG. 4 by the broken lines 42. In use, the hi-lo measurement system moves along the joint to be welded, and effects a hi-lo measurement every ¼ degree (equivalent to over 1,000 measurements around the circumference). The joint is thus effectively scanned by the laser-light and camera system. The images are received by the converter board 30 and then transmitted via the umbilical to a local welding control system including a computer processor. The hi-lo measurements can then be processed and analysed to provide an indication of the degree of alignment.

The arrangement of the camera and laser light source is such that an absolute accuracy of measurement of the order of 0.1 mm or better (absolute accuracy, accounting for all variation in parameters and drift due to for example temperature) is achievable.

A method of welding two pipes together including measuring the alignment of the pipes with the internal line-up clamp device 20 of the first embodiment will now be described.

A first pipe end is defined by a pipeline (having an internal diameter of about 600 mm), which in this embodiment is being laid at sea and thus leads to the sea-bed. A second pipe end is defined by a free pipe section to be welded to the end of the pipeline thereby extending the length of the pipeline. In this case, the pipes are INOX (steel) pipes. The pipe ends are brought together and into alignment. An operator rotates the free pipe section about its axis and translates the pipe-section so that the pipe ends are brought into a position of best alignment as judged by manual inspection by the operator. The ILUC device 20 is operated, the clamp members 26 moving radially outwardly, to clamp the two pipe ends together, with the ends touching, in this position. The welding apparatus is mounted on the exterior of the pipes and all other “fit-up” actions are completed so that the welding apparatus and pipes are all ready for performance of the welding step.

After fit-up has been completed and the pipes are ready to be welded, the hi-lo measurement system is then operated to measure the degree of alignment. Thus, the hi-lo measurement system rotates about the axis of the pipes, such that the hi-lo measurement system completes a whole rotation about the circumference of the interior of the pipes and performs a continuous scan of the profile of the joint. The data is sent from the hi-lo measurement system to the computer of the local welding control system.

The computer processes the received data and produces output data representative of the degree of (mis-)alignment between the pipes. The data processing step includes analysing the data representative of the profile of the joint in consideration of alignment criteria derived from previous tests and calibration. The alignment criteria are a form of reference data, which may be set having regard to a desired specification. The computer thus outputs an indication of the degree of alignment including an indication as to whether the joint should be welded or whether the pipes need to be better aligned before welding can be commenced. The operator of the local welding control system may also be displayed, via a visual display unit, a representation of the profile of the joint to be welded (showing how the hi-lo measurement varies along the length of the joint).

If the degree of alignment between the pipes is deemed to be unacceptable, then the manual operator is warned and the pipes are manipulated in an attempt to improve the alignment between them.

If the measured data is such that the control unit deems the alignment to be acceptable, then the welding is immediately performed, with the ILUC device, and therefore also the hi-lo measurement system, still inside the pipes and in the region of the joint. The position in which the pipes are clamped together also remains substantially unchanged.

The welding step is therefore performed without delay after the hi-lo measuring step, so that the measurement is made in conditions that very closely match the post-welding conditions, thus reducing the chance of error.

The welding process is accurate and completed entirely from the exterior of the pipes. The root weld is performed sufficiently slowly and accurately that a copper backing plate, copper shoes or the like are not required.

The above embodiment may be considered as a method of welding two pipes together, wherein the method includes the steps of (a) clamping two pipes in a position in which a joint to be welded is defined between the ends of the two pipes, (b) obtaining, by means of a measurement system positioned inside the pipes, an indication of the degree of alignment of the pipes in the region of the joint, whilst the pipes are clamped together in said position, and (c) welding together the two pipes, whilst the pipes remain clamped together in the same said position.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The hi-lo measurement system could be used to recommend how the pipes should be manipulated in order to improve their alignment, if the pipes are found not to be sufficiently well-aligned. The computer could for example output the movements required to attain the best alignment between the pipes.

The hi-lo measurement system could be used to measure additionally the alignment of the pipes after welding, to verify that the pipes have not become misaligned during the welding process.

The internal line-up clamp and hi-lo measurement system could be used in welding pipes together both onshore and offshore.

In the illustrated embodiments, the hi-lo measurement system is effectively mounted on the exterior of the ILUC. It will of course be appreciated that the hi-lo measurement system could alternatively be mounted on the ILUC in such a way as parts of the hi-lo measurement system are not clearly visible from the exterior of the ILUC. Parts of the hi-lo measurement system may for example be integrated inside the ILUC.

The local power supply powering the hi-lo measurement system need not be in the form of a battery, but may instead be a local power unit that is powered by electric power from the umbilical attached to the ILUC. In such a case, the local power unit may regulate and/or transform the power received from the umbilical into electrical power suitable for use by the hi-lo measurement system.

Whilst the illustrated hi-lo measurement system is generally arcuate in shape when viewed from the side, it will be appreciated that other shapes of hi-lo measurement system are possible, especially if components of the hi-lo measurement system are smaller than those illustrated.

There may be a dedicated computer for receiving and processing the data from the hi-lo measurement system.

The illustrated embodiment can of course be used to weld pipes of different materials such as for example cladded or corrosion resistant alloy (CRA) pipes.

The alignment criteria may utilise reference data yielded from numerous previously conducted experiments. Those experiments may for example include measuring the alignment of pipe joints with the hi-lo measurement system and then fatigue testing the welded joint to test the reliability of the weld so performed. From the experiments, correlation between the hi-lo measurements and the reliability/acceptability of the weld joint may be derived and then used in the field in order to assess the reliability/acceptability of the alignment of the pipes in view of the hi-lo measurement data.

The laser light and camera system of the hi-lo measurement system may be in a form similar to that utilised in WO2006/112689. The hi-lo measurement system may utilise means other than a laser light and camera system to perform the measurement. The light source may for example be a non-coherent, but sharply focussed, light source. The camera system may be able to map the geometry of the weld joint without the need for any reference light source. As another alternative, a mechanical, contact-based, measurement system may for example be employed.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A clamping system, comprising:
an internal line-up clamp for aligning two pipes to be welded together at sea when laying a pipeline to the sea-bed, the internal line-up clamp including a clamp body on which is mounted a plurality of clamp members for engaging an inner surface of the pipes; and
a hi-lo measurement system mounted on the internal line-up clamp and arranged to make a hi-lo measurement when the two pipes are clamped together by means the internal line-up clamp.

2. The clamping system according to claim 1, wherein the hi-lo measurement system is an optical measurement system.

3. The clamping system according to claim 1, wherein the pipes have an axis, and the hi-lo measurement system is mounted for rotation around the axis of the pipes.

4. The clamping system according to claim 1, wherein the hi-lo measurement system includes a camera mounted inside the internal line-up clamp.

5. A method of using the clamping system according to claim 1 in a method of welding two pipes together at sea when laying a pipeline to the sea-bed, wherein the method comprises:
using the internal line-up clamp to clamp together the two pipes in a position to form a joint to be welded therebetween,
while the pipes are clamped together in said position, using the hi-lo measurement system to obtain an indication of the degree of alignment of the pipes in the region of the joint, and
welding together the two pipes, while the pipes remain clamped together in the same said position.

6. A method of welding two pipes together at sea when laying a pipeline to the sea-bed, wherein the method comprises:
clamping two pipes in end-to-end configuration to define therebetween a joint to be welded,
obtaining, by a measurement system positioned inside the pipes while the pipes are clamped together, an indication of the degree of alignment of the pipes in the region of the joint, and
welding together the two pipes, while the measurement system remains inside the pipes and in the region of the joint.

7. The method according to claim 6, wherein before commencement of the step of obtaining the indication of the degree of alignment of the pipes, all operations necessary to enable welding of the pipes are completed.

8. The method according to claim 6, wherein the step of obtaining an indication of the degree of alignment of the pipes includes rotating the measurement system about the axis of the pipes.

9. The method according to claim 6, wherein the step of clamping of the two pipes is performed by means of an internal clamping system.

10. The method according to claim 6, wherein the step of clamping of the two pipes includes clamping the two pipes in end-to-end configuration, with one end touching the other, to define therebetween the joint to be welded.

11. The method according to claim 6, wherein the step of welding together the two pipes is performed wholly from the exterior of the pipes.

12. The method according to claim 6, wherein the step of welding together the two pipes is performed whilst the line of the joint to be welded is unsupported from the interior of the pipes.

13. The method according to claim 6, wherein the method includes a step of electronically processing data from the measurement system acquired during the step of obtaining the indication of the alignment of the pipes, in which data processing step the acquired data are compared with reference data and a decision is automatically made as to whether the pipes are sufficiently well aligned for welding or not.

14. The method according to claim 6, wherein the measurement system is a hi-lo measurement system and the step of obtaining an indication of the degree of alignment of the pipes includes taking hi-lo measurements.

15. A hi-lo measurement system suitable for use as the hi-lo measurement system mentioned in claim 1.

16. The clamping system according to claim 1, wherein the plurality of clamp members comprises two sets of clamp members, one set being associated with a first of the two pipes to be welded together, and the second set being associated with a second of the two pipes to be welded together.

17. The clamping system according to claim 1, wherein the clamp members are arranged to engage the inner surface of the pipes by moving outwardly in the radial direction.

18. The clamping system according to claim 1, wherein the hi-lo measurement system includes a light source arranged to illuminate the interior surface of the pipes in the region of the joint to be welded.

19. The clamping system according to claim 18, wherein the light source is a laser light source.

20. The clamping system according to claim 1, wherein the hi-lo measurement system is mounted midway along the length of the internal line-up clamp.

21. A clamping system, comprising:
an internal line-up clamp for aligning two pipes to be welded together at sea when laying a pipeline to the sea-bed, the internal line-up clamp including a clamp body on which is mounted a plurality of clamp members for engaging an inner surface of the pipes;
a hi-lo measurement system mounted on the internal line-up clamp and arranged to make a hi-lo measurement when the two pipes are clamped together by the internal line-up clamp; and
a welding control system for comparing data acquired by the hi-lo measurement system with reference data, wherein the welding control system is arranged to automatically make a decision as to whether or not the pipes are sufficiently well aligned for welding.
